(19) United States
(12) Patent Application Publication
(10) Pub. No.: US 2020/0005192 A1
(43) Pub. Date: Jan. 2, 2020

(54) MACHINE LEARNING ENGINE FOR IDENTIFICATION OF RELATED VERTICAL GROUPINGS

(71) Applicant: PAYPAL, INC., San Jose, CA (US)

(72) Inventors: Dinesh Kumar, Santa Clara, CA (US); Geethamanjusha Melanathurbhaskar, Chennai (IN)

(21) Appl. No.: 16/024,225

(22) Filed: Jun. 29, 2018

(51) Int. Cl. G06N 99/00

(52) U.S. Cl. CPC G06N 99/005

(57) ABSTRACT

A machine learning engine for identification of related vertical groupings may be trained using artificial intelligence and machine techniques and used according to techniques discussed herein. A consumer account may be used to process transactions electronically with merchants. The consumer account may therefore be linked to a transaction history, which may be processed to identify the consumer's vertical transaction list for verticals of previous transactions. This may be aggregated for a merchant used by the consumer, and may be weighted before sending back to the consumer. Multiple iterations of aggregating and weighing the merchant and consumer lists may be applied to determine highest ranked verticals for consumers and merchants based on multiple degrees of separation between certain merchants and consumers. Using the weighted lists, verticals may be identified for consumers that the consumer may not have previously transacted within, which may be used to provide a recommendation.

### TECHNICAL FIELD

The present application generally relates to machine learning and artificial intelligence, and more specifically to a machine learning engine that provides identification of item verticals based on electronic transaction data.

### BACKGROUND

Various types of service providers may provide electronic transaction processing services to users, merchants, other types of businesses, and different entities. These service providers may provide online accounts to users for use in processing transactions electronically, which may be used to process transactions electronically with merchants over a network. Merchants and service providers may wish to provide recommendations to increase the number of processed transactions by informing users of potential interests in merchant products or services. However, previous recommendation engines merely use past user history, such as a browsing and/or transaction history, and do not link different product or service groupings based on shared characteristics. Therefore, there is a need to provide improved recommendations that lead to increased numbers of electronic transactions processed over computer networks.

### BRIEF DESCRIPTION OF THE DRAWINGS

FIG. 1 is a block diagram of a networked system suitable for implementing the processes described herein, according to an embodiment;

FIG. 2A is an exemplary block diagram of a consumer vertical list for an account based on transactions processed by the account with one or more merchants, according to an embodiment;

FIG. 2B is an exemplary block diagram of a merchant vertical list for a merchant based on consumer transactions for the merchant, according to an embodiment;

FIG. 3A is an exemplary system environment where multiple consumer vertical lists may be aggregated for a merchant, according to an embodiment;

FIG. 3B is an exemplary system environment where a consumer vertical lists may be aggregated across multiple merchant vertical lists, according to an embodiment;

FIG. 4 is a flowchart of an exemplary process for a machine learning engine for identification of related vertical groupings, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for a machine learning engine for identification of related vertical groupings. Systems suitable for practicing methods of the present disclosure are also provided.

Service providers may provide electronic transaction processing for online transactions where the buyer (e.g., a user or consumer) may be located in a different location from a seller (e.g., a merchant or another user selling an item), such as a different city, county, state, country, or other geographically different location. The user may purchase from multiple online merchants, and may purchase in different verticals, which may correspond to general groupings for types of products and/or services (referred to herein as an “item” or “items”). In order to process transactions within different verticals, the user may utilize an account with an online service provider, such as a transaction processor. The account may therefore have a transaction history, which may be processed to determine the number of transactions processed by the account in each item vertical. This may generate a user or consumer vertical list. This vertical list may be merchant specific, or may be across all merchants used by the user. The vertical list may also include a number of transactions processed in each vertical grouping. A particular merchant may receive the user's vertical list, and may aggregate the user's vertical list across all other consumers for the merchant.

Thus, other users' transaction histories that are associated with the merchant may also be processed to determine their user vertical lists, and the merchant may aggregate them to generate a merchant vertical list having all verticals used by the consumers of the merchant and the number of transactions for each vertical grouping. A machine learning engine may perform this process to generate the merchant vertical list. This may correspond to the specific merchant and their transactions and verticals, or may include verticals and vertical counts for other merchants that are included in the user vertical lists. The service provider and/or merchant may then weigh the merchant vertical list using a weight set by the merchant or service provider (e.g., 0.4 multiplied by the number of transactions in each vertical) with the machine learning engine. This weighted list may be sent back to the user to determine other verticals that the user has not previously transacted within. One of more of these verticals may be used to generate a recommendation for an item in the vertical, such as a highest weighed vertical (e.g., vertical having the highest number after the weight is applied) that the user has not previously purchased an item within or vertical associated with another vertical used by the user. The user may also receive this weighted merchant vertical list from other merchants, and may aggregate all of them to identify those verticals not used and having a high or highest weighted total. This may be sent back to each merchant for further aggregating and processing, which may be performed for multiple iterations or until system saturation by the machine learning engine. Moreover, the service provider may then process user responses and further transaction processing based on the recommendation to update the machine learning engine.

One or more entities, such as personal users or consumers, groups of users, merchants, businesses, or other commercial or governmental agencies, may wish to process a transaction electronically for physical or virtual items, services, and/or benefits. For example, a first user may wish to purchase an item from an online merchant or otherwise engage in electronic transactions. Various service providers may provide transaction processing services that may allow these two or more entities to engage in electronic transaction processing. The user may further be required to establish the user's account with the service provider in order to engage in electronic transaction processing. The user may be required to provide identification information to establish the account, such as personal information for a user, business or merchant information for such an entity, or other types of identification information including a name, address, and/or other information. The user may also be required to provide financial information, including payment card (e.g., credit/debit card) information, bank account information, gift card information, and/or benefits/incentives, which may be used to provide funds to the account and/or an instrument for transaction processing. In order to create an account, the user may be required to select an account name and/or provide authentication credentials, such as a password, personal identification number (PIN), answers to security questions, and/or other authentication information. Similar information as that discussed above may also be provided by a merchant involved in a transaction. However, in other embodiments, the merchant's account may be external to the service provider and/or other data may be used to establish the merchant's account.

The user's account may then be used by the first user to perform electronic transaction processing. A computing device may execute a transaction processing application, which may be configured to send and receive payments to another party, such as another user and/or a merchant, or otherwise engage in transaction processing. In various embodiments, a website may provide the transaction processing services, and thus may be accessed by a web browser application. The application (or website) may be associated with a payment provider, such as PayPal® or other online payment provider service, which may provide payments and the other aforementioned transaction processing services on behalf of users, merchants, and other entities. A transaction may therefore be created and processed through an account of a user. The user may access one or more interfaces for a merchant (e.g., in a merchant application or website), generate the transaction, and provide the account for transaction processing. For example, a graphical user interface of a device used to access the account (e.g., through an authentication process and an account access portal in a website or a dedicated application) may display the interfaces and allow a user to interact with the merchant. The service provider may receive a transaction processing request, which may include the transaction information. The service provider may process the transaction, and, if successful, may provide a receipt. This may be performed multiple times for an account so that the account becomes associated with a transaction history that documents and records the previously processed transactions by the account.

Thus, an account may have a transaction history, which may be used to generate a consumer or account specific vertical list of each vertical having a transaction in the transaction history and a number of transactions for each vertical. A vertical may correspond to a particular market where merchants offer items and/or services in a particular industry, item type, trade, or need for a group of consumers. A vertical may correspond to a grouping or identification for a transaction or items/services within the transaction (e.g., cars, toys, gaming, fashion, cellphones, etc., as well as sub-categories within a large category such as auto-parts for cars or shirts for fashion). Each transaction in the transaction history may correspond to a vertical used to categorize the transaction and item type in the transaction. For example, an account transaction history may be processed to identify each vertical that the user purchased items in (e.g., fashion, cars, electronics, etc.) and a number of transactions per vertical over a selected period of time (e.g., the last six months or one year). This may be generated by the user's device using the account (e.g., by an application on the device), by the service provider, or by a merchant.

Vertical grouping may be performed for the specific user's account transaction history, as well as other users of a merchant to identify multiple consumer vertical lists depending on their purchasing behavior with the merchant. The binning of the user data may be performed using a clustering algorithm on the user transaction data to identify the users' number of transactions in a particular vertical intelligently by the machine learning and recommendation engine. For example, clustering by the engine may identify particular transactions in a vertical through partitioning observations into a number of clusters, or verticals. Thus, other users for a merchant may be identified and their transaction history processed to generate a plurality of consumer vertical lists based on the number of transactions of purchase in a vertical. Such data may be accessed and used in real-time as the engine determines the consumer vertical lists when determining a recommendation for a user. The engine may perform real-time processing of the data to determine recommendations. However, in other embodiments, the user/account past transaction information and/or the merchant transaction information may be preprocessed so that each user's vertical transaction list may be previously determined and sent to the merchant for use at a future time when generating a recommendation.

The merchant may receive each of the consumer vertical lists and may use these lists to generate a merchant transaction list that is a listing of all verticals used by consumers of the merchant and the number of transactions by all of the users in each vertical. This may be done only for the transaction of the merchant (e.g., for an item sold by the merchant specifically), or may further include all the verticals used by the consumers of the merchant across all merchants having transactions processed by the consumers with other merchants in each of the consumer account's transaction history. The merchant vertical list and corresponding recommendation may be based on one or more rules, weights, or processing algorithms to determine a value to assign to each vertical based on the weight and the number of transactions in each vertical for the merchant vertical list. Such rules or weights may provide different factors for data when determining the weighted merchant vertical list. A weight may correspond to a specific number or amount that is used to adjust the number of transaction in each vertical to account for merchants and consumers separated from the direct merchant to consumer transaction verticals by one or more degrees, chains, or steps. For example, a 0.4 weight may be used as a multiplier for a merchant vertical list so that each vertical has its number of transactions in the vertical across all consumers for the merchant reduced by 0.4. Thus, when the merchant vertical list is sent back to the user's account and returned to the merchant's account after the user's account re-aggregates across all of its merchants, the weight may reduce those merchants and consumers separated by multiple degrees (e.g., not having a direct transaction but sharing a common entity that the user's/merchant's account transacts with), as discussed further herein. This may account for the separation degrees by the machine learning engine.

After weighing the merchant transaction verticals using the weight by the machine learning engine, the merchant transaction vertical list may be sent to the accounts/devices for each of the consumers for the merchant, including the original user's account that determined the first consumer vertical list discussed herein. This may be used by a recommendation process and engine of a service provider, merchant, or other entity to determine those verticals that the user has not purchased an item within and the likelihood that the user may be interested in that vertical. For example, a vertical for a merchant having a highest weighted score (e.g., number of transactions adjusted by the weight) may be of interest to that user based on the other consumers of the merchant. Using the vertical list data for the user, the merchant, and/or other users/merchants, the service provider may generate one or more recommendation rules that define the propensity, probability, or likelihood that a user in one location will purchase an item in a vertical. In order to generate rules, the engine may apply machine learning to the data to identify the propensity for a user's account to purchase from a merchant in a transaction in that vertical.

Prior to determining recommendation rules and/or generating a recommendation, multiple iterations may be performed of consumer vertical lists being determined and aggregated, sent to a merchant account's machine learning engine and being aggregated and weighed, and sent back to the consumer. By performing multiple iterations of data processing over large data sets, similarities between different verticals may be determined and those verticals that are commonly purchased together or by the same consumers of a merchant may be determined, as well as items that are uncommonly co-purchased or shared in the same transaction history. Thus, recommendation rules may be determined. Once the weighted merchant vertical list is received by each consumer's account of that merchant, each consumer's account may be further processed by the machine learning engine to aggregate all of their received merchant vertical lists across all merchants, which may be sent back to each of their merchants' accounts, and reweighed after the merchant again aggregates across all of its consumers. This weighted merchant transaction vertical list (which has been weighted twice through two iterations of processing) may then be returned to each of the merchant's consumers, and this list may be used for recommendation rule determination by a machine learning engine or may go through one or more additional iterations of the aforementioned process until system saturation or a maximum iteration number is determined.

For example, a particular first merchant may generate their vertical list for all transactions processed by the first merchant across all consumers, and may weigh the list as previously discussed. Once sent back to the user's account, the user's account may also receive a similarly processed merchant vertical list for a second merchant, as well as a plurality of other merchants. The machine learning engine may aggregate the verticals and weighted number of transactions in each vertical for all of the merchant vertical lists for a user's account. This may then be sent to each of the user's merchants. Each of the user's merchants may receive this from all of their customers and may re-aggregate all of these lists. Once the merchant's vertical list is again aggregated across all merchants, the weight may again be applied, and this list may be sent back to each consumer including the user.

Based on the multiple iterations, the machine learning engine may include data from consumers and merchants that are separated by one or more degrees. A recommendation rule may be generated by the machine learning engine for a user's account, which corresponds to a vertical that the account does not have a previous transaction in, but is related to the account's other verticals and/or is a highest weighted score or amount in the consumer's vertical list after processing through multiple iterations. A threshold score may also be required to be met to determine whether the vertical is of interest to the user. In response to the recommendation rule, the service provider may then execute a recommendation process and generate output data. For example, an item within the recommended vertical may be determined from one of the merchants used by the user (e.g., having a transaction in the user's account history) or from a related merchant connected to the user's account through other consumers' accounts. A recommendation notification, such as an advertisement through email, pop-up notification, push notification, text message, or other message data, may be generated and may be transmitted to the user's device or account for retrieval through the device.

Using the feedback, a machine learning process of the service provider's engine may be executed to update parameters and data for the engine, change weights and/or data considerations by the engine, or otherwise update the engine based on a response to the notification. For example, the user may not respond to the recommendation, may delete the recommendation, or may ignore and not purchase within that vertical, which indicates an incorrect recommendation. The user's account may also be used to purchase the item or transact within that vertical, which may indicate a correct recommendation. The aforementioned data factors may be updated based on the feedback, as well as changing real-time data, and weights may be adjusted based on the overall value of data points within the engines processing considerations. The engine may also receive metrics for outcomes of the notification, and may determine misclassifications of transaction location processing within verticals based on the outcome. Thus, the engine may determine an accuracy of the engine, which may be used to update data considerations and weights applied to data in the recommendation determination. The engine may continue to execute the machine learning process with further recommendations to continue updating the engine, which may then be used to provide more accurate recommendations based on changing data, parameters, and/or data weights.

Thus, the service provider may utilize real-time data accrued during a transaction to make real-time recommendations and more correctly predict user interests. This allows recommendation of items to occur at a time prior to completion of processing an electronic transaction and provides more accurate generation and output of data to users so that users do not receive unnecessary communications of little interest to the user. This is increasingly necessary with online transaction processing and account use across long distances and with a large amount of online data. As a result, when utilizing an online account for merchant engagement and browsing, the systems and processes disclosed herein may provide increased prediction of user behavior and interests.

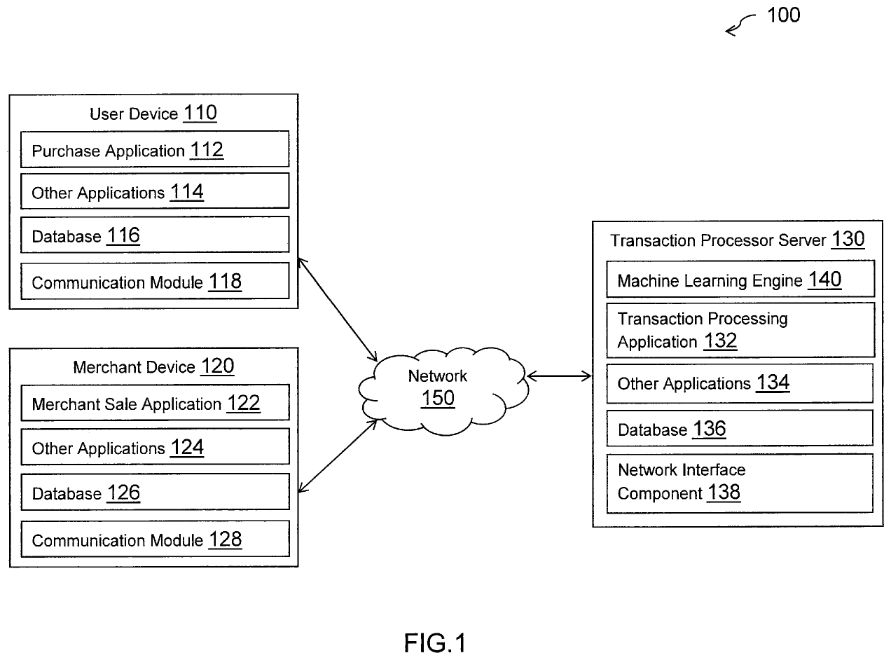

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a user device 110, a merchant device 120, and a transaction processor server 130 in communication over a network 150. User device 110 may be utilized to access the various features available for user device 110, which may include processes and/or applications associated with transaction processing for a transaction with merchant device 120 using an account with transaction processor server 130. Based on an account history for the account for the electronic transaction processing, transaction processor server 130 may utilize a machine learning engine to determine a recommendation for the account that is accessible using user device 110. The recommendation may be based on aggregating consumer verticals and transactions in each vertical for the merchant associated with merchant device 120, weighting, and sending back to the account through multiple iterations.

User device 110, merchant device 120, and transaction processor server 130 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 150.

User device 110 may be implemented as a communication device that may utilize appropriate hardware and software configured for wired and/or wireless communication with merchant device 120, and/or transaction processor server 130. For example, in one embodiment, user device 110 may be implemented as a personal computer (PC), telephonic device, a smart phone, laptop/tablet computer, wristwatch with appropriate computer hardware resources, eyeglasses with appropriate computer hardware (e.g. GOOGLE GLASS®), other type of wearable computing device, implantable communication devices, and/or other types of computing devices capable of transmitting and/or receiving data, such as an IPAD® from APPLE®. User device 110 may correspond to a device of a consumer or a fraudulent party utilizing an account during electronic transaction processing with a disparate entity, such as the merchant associated with merchant device 120. Although only one communication device is shown, a plurality of communication devices may function similarly.

User device 110 of FIG. 1 contains a purchase application 112, other applications 114, a database 116, and a communication module 118. Purchase application 112 and other applications 114 may correspond to executable processes, procedures, and/or applications with associated hardware. In other embodiments, user device 110 may include additional or different modules having specialized hardware and/or software as required.

Purchase application 112 may correspond to one or more processes to execute software modules and associated devices of user device 110 to process electronic transactions over a network with one or more other services and/or users. In this regard, purchase application 112 may correspond to specialized hardware and/or software utilized by a user of user device 110 that may be used to access a website or an application interface of a merchant or service provider that allows user device 110 to select items for purchase and engage in electronic transaction for the items with the merchant. Purchase application 112 may utilize one or more user interfaces, such as graphical user interfaces presented using an output display device of user device 110, to enable the user associated with user device 110 to process the transaction. In various embodiments, purchase application 112 may correspond to a general browser application configured to retrieve, present, and communicate information over the Internet (e.g., utilize resources on the World Wide Web) or a private network. However, in other embodiments, purchase application 112 may include a dedicated application of transaction processor server 130 or other entity (e.g., a merchant), which may be configured to assist in processing transactions electronically.

Purchase application 112 may therefore access an account and receive recommendations for the account. Purchase application 112 may be used to process a transaction using the account based on the recommendation, or may otherwise respond to the recommendation. During electronic transaction processing, purchase application 112 may be utilized to select payment instrument(s) for use in providing payment for a purchase transaction, transfer, or other financial process. As discussed herein, purchase application 112 may utilize user financial information, such as a credit card, bank account, or other financial account, as a payment instrument when providing payment information. Additionally, purchase application 112 may utilize a digital wallet stored with an account with a payment provider, such as transaction processor server 130, as the payment instrument, for example, through accessing a digital wallet or account of a user with transaction processor server 130 through entry of authentication credentials and/or by providing a data token that allows for processing using the account. Purchase application 112 may be utilized to view the results of payment, for example, using transaction histories and other post-transaction process. Purchase application 112 may further be used to access and/or navigate to one or more interfaces to provide feedback based on the recommendation, which may be utilized by transaction processor server 130 during a machine learning process for the recommendation.

In various embodiments, user device 110 includes other applications 114 as may be desired in particular embodiments to provide features to user device 110. For example, other applications 114 may include security applications for implementing client-side security features, programmatic client applications for interfacing with appropriate application programming interfaces (APIs) over network 150, or other types of applications. Other applications 114 may also include email, texting, voice and IM applications that allow a user to send and receive emails, calls, texts, and other notifications through network 150. In various embodiments, other applications 114 may include financial applications, such as banking applications. Other applications 114 may also include other location detection applications, which may be used to determine a location for the user, such as a mapping, compass, and/or GPS application, which can include a specialized GPS receiver that obtains location information for user device 110 and processes the location information to determine a location of user device 110 and the user. Other applications may include social networking applications, media viewing, and/or merchant applications. Other applications 114 may include device interface applications and other display modules that may receive input from the user and/or output information to the user. For example, other applications 114 may contain software programs, executable by a processor, including a graphical user interface (GUI) configured to provide an interface to the user. Other applications 114 may therefore use devices of user device 110, such as display devices capable of displaying information to users and other output devices, including speakers.

User device 110 may further include database 116 stored in a transitory and/or non-transitory memory of user device 110, which may store various applications and data and be utilized during execution of various modules of user device 110. Database 116 may include, for example, identifiers such as operating system registry entries, cookies associated with purchase application 112 and/or other applications 114, identifiers associated with hardware of user device 110, or other appropriate identifiers, such as identifiers used for payment/user/device authentication or identification, which may be communicated as identifying user device 110 to transaction processor server 130. Database 116 may include transaction information for previously processed transactions, including a list of merchants, verticals, and weighted merchant vertical lists. However, in other embodiments, the information may be stored with an account by a server or networked device, such as merchant device 120 or transaction processor server 130. Database 116 may also store recommendations for display.

User device 110 includes at least one communication module 118 adapted to communicate with merchant device 120 and/or transaction processor server 130. In various embodiments, communication module 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 118 may communicate directly with nearby devices using short range communications, such as Bluetooth Low Energy, LTE Direct, WiFi, radio frequency, infrared, Bluetooth, and near field communications.

Merchant device 120 may be implemented as a computing device that may utilize appropriate hardware and software configured for wired and/or wireless communication with user device 110 and/or transaction processor server 130. For example, in one embodiment, merchant device 120 may be implemented as a personal computer (PC), telephonic device, a smart phone, laptop/tablet computer, wristwatch with appropriate computer hardware resources, eyeglasses with appropriate computer hardware (e.g. GOOGLE GLASS®), other type of wearable computing device, implantable communication devices, and/or other types of computing devices capable of transmitting and/or receiving data, such as an IPAD® from APPLE®. Merchant device 120 may be used to provide item sales data over a network to user device 110 for the sale of items, for example, through an online merchant marketplace. In certain embodiments, merchant device 120 may be used to host a website and/or provide website or application data for use in item sales; however, merchant device 120 may also provide item sales through another service provider's platform. In certain embodiments, merchant device 120 may also provide sales through a physical merchant location. Although only one device is shown, a plurality of devices may function similarly.

Merchant device 120 of FIG. 1 contains a merchant sale application 122, other applications 124, a database 126, and a communication module 128. Merchant sale application 122 and other applications 124 may correspond to executable processes, procedures, and/or applications with associated hardware. In other embodiments, merchant device 120 may include additional or different modules having specialized hardware and/or software as required.

Merchant sale application 122 may correspond to one or more processes to execute modules and associated specialized hardware of merchant device 120 that provide sales, checkout, and payment processes for a transaction to purchase one or more items for sale from the merchant corresponding to merchant device 120. In this regard, merchant sale application 122 may correspond to specialized hardware and/or software of merchant device 120 to provide a convenient interface to permit a merchant to enter, view, and/or edit items and/or services for purchase by a user. For example, merchant sale application 122 may be implemented as an application having a user interface enabling the merchant to enter item information and request payment for a transaction on checkout/payment of one or more items/services. In certain embodiments, merchant sale application 122 may correspond more generally to a web browser configured to view information available over the Internet or access a website corresponding to the merchant and/or transaction processor server 130. Thus, merchant sale application 122 may provide item sales through an online marketplace using the website of the merchant.

Once a payment amount is determined for a transaction for items to be purchased by a customer, the merchant may request payment from the customer, for example, through transaction information input to user device 110. The provided transaction information may be communicated to merchant device 120 with the transaction or transaction request. A service provider server, such as transaction processor server 130, may process the transaction with the provided transaction information and determine whether to approve or decline the transaction using a payment instrument for the payment process. Merchant sale application 122 may then receive the results of the transaction processing, and complete the transaction with the customer, for example, by providing the customer the items for the transaction or declining the transaction where the customer is not authenticated or the transaction is not authorized (e.g., insufficient funds). Merchant sale application 122 and/or transaction processor server 130 may provide the transaction results for determination of consumer vertical lists. Additionally, merchant sale application 122 may provide additional information to transaction processor server 130 for determination of a merchant vertical list, such as consumer vertical lists received by merchant device 120 and/or merchant transaction information for past transactions, or may determine a merchant vertical list using received consumer vertical lists.

In various embodiments, merchant device 120 includes other applications 124 as may be desired in particular embodiments to provide features to merchant device 120. For example, other applications 124 may include security applications for implementing client-side security features, programmatic client applications for interfacing with appropriate application programming interfaces (APIs) over network 150, or other types of applications. Other applications 124 may also include email, texting, voice and IM applications that allow a user to send and receive emails, calls, texts, and other notifications through network 150. In various embodiments, other applications 124 may include financial applications, such as banking applications. Applications 124 may include device interface applications and other display modules that may receive input from the user and/or output information to the user. For example, other applications 124 may contain software programs, executable by a processor, including a graphical user interface (GUI) configured to provide an interface to the user. Other applications 124 may therefore use devices of merchant device 120, such as display devices capable of displaying information to users and other output devices, including speakers.

Merchant device 120 may further include database 126 stored in a transitory and/or non-transitory memory of merchant device 120, which may store various applications and data and be utilized during execution of various modules of merchant device 120. Database 126 may include, for example, identifiers such as operating system registry entries, cookies associated with merchant sale application 122 and/or other applications 124, identifiers associated with hardware of merchant device 120, or other appropriate identifiers, such as identifiers used for payment/user/device authentication or identification. In various embodiments, database 126 may include merchant vertical list information, previous transaction processing results and transaction histories, and other information necessary to determine a recommendation for an account used by user device 110.

Merchant device 120 includes at least one communication module 128 adapted to communicate with user device 110 and/or transaction processor server 130. In various embodiments, communication module 128 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 128 may communicate directly with nearby devices (e.g., merchant device 120) using short range communications, such as Bluetooth Low Energy, LTE Direct, WiFi, radio frequency, infrared, Bluetooth, and near field communications.

Transaction processor server 130 may be maintained, for example, by an online service provider, which may provide transaction processing services on behalf of users and/or merchants including recommendation determination based on processed transaction vertical information. In this regard, transaction processor server 130 includes one or more processing applications which may be configured to interact with user device 110, merchant device 120, and/or another device/server to facilitate transaction processing. In one example, transaction processor server 130 may be provided by PAYPAL®, Inc. of San Jose, Calif., USA. However, in other embodiments, transaction processor server 130 may be maintained by or include another type of service provider, which may provide connection services to a plurality of users.

Transaction processor server 130 of FIG. 1 includes a machine learning engine 140, a transaction processing application 132, other applications 134, a database 136, and a network interface component 138. Machine learning engine 140, transaction processing application 132, and other applications 134 may correspond to executable processes, procedures, and/or applications with associated hardware. In other embodiments, transaction processor server 130 may include additional or different modules having specialized hardware and/or software as required.

Machine learning engine 140 may correspond to one or more processes to execute software modules and associated specialized hardware of transaction processor server 130 to analyze transaction and account information for an account, a merchant, and other consumers/merchants that are shared in account histories through one or more degrees of separation and determine recommendations for new verticals based on closest similar verticals. In this regard, machine learning engine 140 may correspond to specialized hardware and/or software to receive transaction information and/or access account information for determination of consumer and merchant vertical lists. The consumer vertical list may be generated based on transactions processed by transaction processing application 132 for an account, and may correspond to all verticals that the account purchased an item in and a number of transactions completed by the account in each vertical. This list for the account used by user device 110 and all other consumer accounts for a merchant associated with merchant device 120 may then be aggregated for the merchant, and a weight may be applied. After applying the weight, machine learning engine 140 may associate the weighted merchant vertical list with each of the merchant's consumer accounts, such as the account used by user device 110. This may be performed for each of the merchants that the account has previously transacted with. Thus, the account may be associated with multiple weighted merchant vertical lists. Machine learning engine may then aggregate the multiple weighted merchant vertical lists for each account (e.g., the account used by user device 110). After aggregating for the account, this list may be again associated back with each of the account's merchants, and the process may repeat for one or more additional iterations of weighting and aggregating. Once the iterations are completed, each consumer account, including the one used by user device 110, may have a processed and weighted consumer transaction vertical list that has data over multiple merchants and related consumers. Additionally, a merchant may have a merchant transaction vertical list.

Machine learning engine 140 may then execute an action based on the consumer account's vertical transaction list. The action may correspond to generation of a recommendation based on a next highest or most closely related vertical within the account's weighted consumer vertical transaction list that the account has not previously purchased an item in, such as an unused item vertical. For example, the account used by user device 110 may receive a recommendation for an item in a new vertical that is the highest scored (e.g., most weighted transactions) in the weighted consumer vertical transaction list. The notification for the recommendation may correspond to an advertisement or other output data that identifies the item, a merchant to purchase the item from, and other necessary information. The notification may be output to user device 110 or accessible using the account. Machine learning engine 140 may also execute a machine learning process to update machine learning engine 140, which may be based on the recommendation, as well as feedback for the recommendation, such as whether the user ignores or views a recommendation, or processed transaction associated with the recommendation. The machine learning process may update parameters and data for the recommendation engine of machine learning engine 140, change weights and/or data considerations by the engine, or otherwise update the engine based on the response to the recommendation. The aforementioned data factors may be updated based on the feedback, as well as changing real-time data and/or calculations for recommendations. Machine learning engine 140 may receive feedback for various outcomes of the recommendation, and may revise the parameters, weights, and/or vertical calculation based on such data.

Transaction processing application 132 may correspond to one or more processes to execute software modules and associated specialized hardware of transaction processor server 130 to provide payment and transaction processing services to merchants and users, for example though an account and/or payment instruments of the user to an account of the merchant, where the services may be used to generate a transaction history that is processed by machine learning engine 140. In this regard, transaction processing application 132 may correspond to specialized hardware and/or software to provide transaction processing and payment services through accounts, including digital wallets storing payment instruments. The services may allow for a payment through a payment instrument, including a credit/debit card, banking account, payment account with transaction processor server 130, and/or other funding instrument. The payment may be used to provide a value for a transaction. In order to establish an account to send and receive payments, transaction processing application 132 may receive information requesting establishment of the account. The information may include user personal, business, and/or financial information. Additionally, the information may include a login, account name, password, PIN, or other account creation information. The entity establishing the account may provide a name, address, social security number, or other personal or business information necessary to establish the account and/or effectuate payments through the account. Transaction processing application 132 may further allow the entity to service and maintain the payment account, for example, by adding and removing funding instruments.

Transaction processing application 132 may be used to provide a payment for a transaction after an establishment phase of the transaction. Transaction processing application 132 may process the payment to provide the value for the transaction. Based on a fraud assessment, transaction processing application 132 may provide a recommendation for the account. Transaction processing application 132 may also be used to respond to the recommendation by processing another transaction. Transaction processing application 132 may debit an account of the user and provide the payment to an account of the merchant. Transaction processing application 132 may also be used to provide transaction histories for processed transactions.

In various embodiments, transaction processor server 130 includes other applications 134 as may be desired in particular embodiments to provide features to transaction processor server 130. For example, other applications 134 may include security applications for implementing server-side security features, programmatic client applications for interfacing with appropriate application programming interfaces (APIs) over network 150, or other types of applications. Other applications 134 may contain software programs, executable by a processor, including a graphical user interface (GUI), configured to provide an interface to the user when accessing transaction processor server 130, where the user or other users may interact with the GUI to more easily view and communicate information. In various embodiments, other applications 134 may include connection and/or communication applications, which may be utilized to communicate information to over network 150.

Additionally, transaction processor server 130 includes database 136. As previously discussed, the user and/or the merchant may establish one or more digital wallets and/or accounts with transaction processor server 130. Digital wallets and/or accounts in database 136 may include user information, such as name, address, birth date, payment instruments/funding sources, additional user financial information, user preferences, and/or other desired user data. Users may link to their respective digital wallets and/or payment accounts through an account, user, merchant, and/or device identifier. Thus, when an identifier is transmitted to transaction processor server 130, e.g., from user device 110, one or more digital wallets and/or payment accounts belonging to the users may be found. Database 136 may also store digital gift card data, as well as data for one or more devices and/or accounts involved in the establishment and use of the digital gift card. Additionally, recommendations for an item vertical based on a consumer transaction listed after being weighted and processed through multiple iterations, and feedback from the recommendation may be stored in database 136.

In various embodiments, transaction processor server 130 includes at least one network interface component 138 adapted to communicate with user device 110 and/or merchant device 120 over network 150. In various embodiments, network interface component 138 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 150 may be implemented as a single network or a combination of multiple networks. For example, in various embodiments, network 150 may include the Internet or one or more intranets, landline networks, wireless networks, and/or other appropriate types of networks. Thus, network 150 may correspond to small scale communication networks, such as a private or local area network, or a larger scale network, such as a wide area network or the Internet, accessible by the various components of system 100.

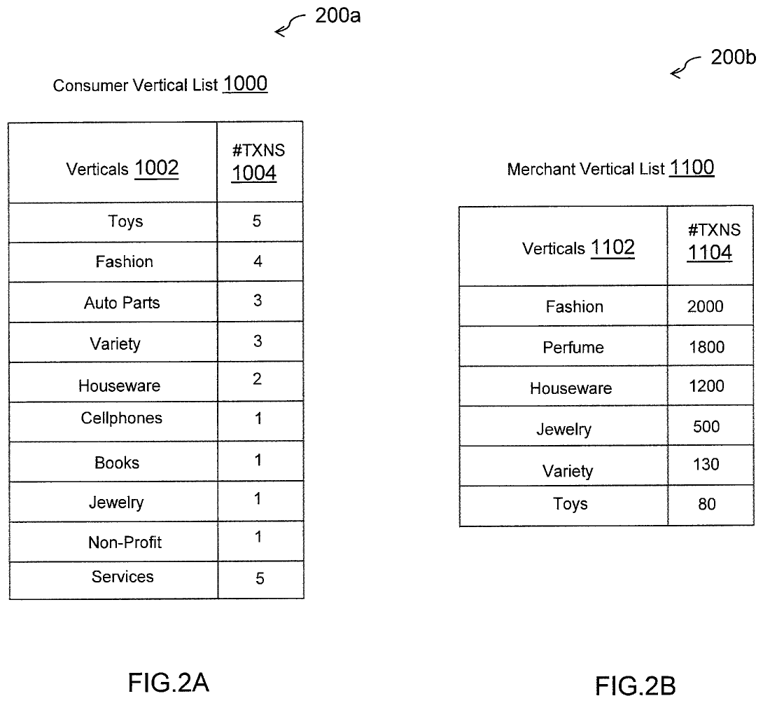

FIG. 2A is an exemplary block diagram of a consumer vertical list for an account based on transactions processed by or through the account with one or more merchants, according to an embodiment. Environment 200a includes a consumer vertical list 1000 generated by a machine learning process, such as one provided by machine learning engine 140 of transaction processor server 130 described in system 100 of FIG. 1. In this regard, consumer vertical list 1000 may be generated using or based on a transaction history for an account provided by transaction processor server 130 and/or used to process transactions with a merchant, such as the merchant associated with merchant device 120 described in system 100 of FIG. 1.

Consumer vertical list 1000 includes verticals 1002 and a number of transactions 1004 for each of verticals 1002. Verticals 1002 may each correspond to a grouping, organization, or characteristic type of items purchased in transactions, such as “toys,” “fashion,” or “jewelry.” Each of verticals 1002 has a corresponding transaction found in the user's account transaction history, such as a purchase of an item in that vertical. The transaction history may be limited in scope to only go back a certain amount of time to give preference to recent transactions. Number of transactions 1004 correspond to the number of transactions found in a particular one of verticals 1002. For example, number of transaction 1004 for “toys” in verticals 1002 includes 5 transactions, while “fashion” has 4 and “jewelry” has 1. Thus, consumer vertical list 1000 may correspond to processed and organized data that is clustered from a user's account transaction history and is then provided to a merchant for the determined of the vertical list in FIG. 2B.

FIG. 2B is an exemplary block diagram of a merchant vertical list for a merchant based on consumer transactions for the merchant, according to an embodiment. Environment 200b includes a merchant vertical list 1100 generated by a machine learning process, such as one provided by machine learning engine 140 of transaction processor server 130 described in system 100 of FIG. 1. In this regard, merchant vertical list 1100 may be generated by aggregating all of the merchant's consumer vertical lists for the merchant's consumers, such as consumer vertical list 1000 described in environment 200a of FIG. 2A with other consumer transaction lists for consumers of the merchant.

Merchant vertical list 1100 includes verticals 1102 and a number of transactions 1104 for each of verticals 1102. Verticals 1002 may each correspond to a grouping, organization, or characteristic type of items sold by the merchant to its consumers, such as “fashion,” “perfume,” or “houseware,” and includes at least those transactions found in consumer vertical list 1000 that were with the merchant associated with merchant vertical list 1100. For example, merchant vertical list 1100 may correspond to a list of only those verticals sold by the merchant and for transactions between specifically that merchant and its consumers. However, in other embodiments and/or after additional iterations of the machine learning process to aggregate and weight vertical lists, merchant vertical list 1100 may include verticals that the merchant does not sell in. Each of verticals 1102 has a corresponding transaction found in the merchant's transaction history with its consumers, such as a sale of an item in that vertical. Number of transactions 1104 correspond to the number of transactions found in a particular one of verticals 1102. For example, number of transaction 1104 for “fashion” in verticals 1102 includes 2000 past transactions sold by the merchant to its consumers and/or found in its consumers vertical lists after aggregating from other merchants, while “perfume” has 1800 and “houseware” has 1200. Thus, merchant vertical list 1100 may correspond to aggregated data from merchant vertical lists across all of the merchant's consumers and is then weighted and provided back to each of its consumers or the merchant. The vertical lists may then go through one or more additional iterations of this process to generate a vertical list for recommendations.

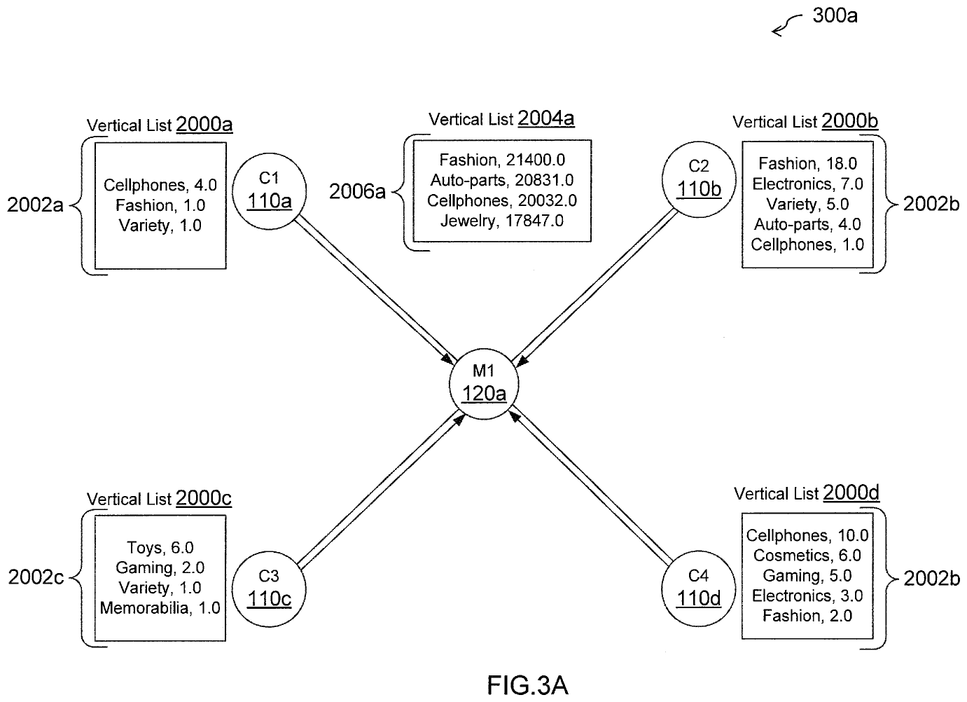

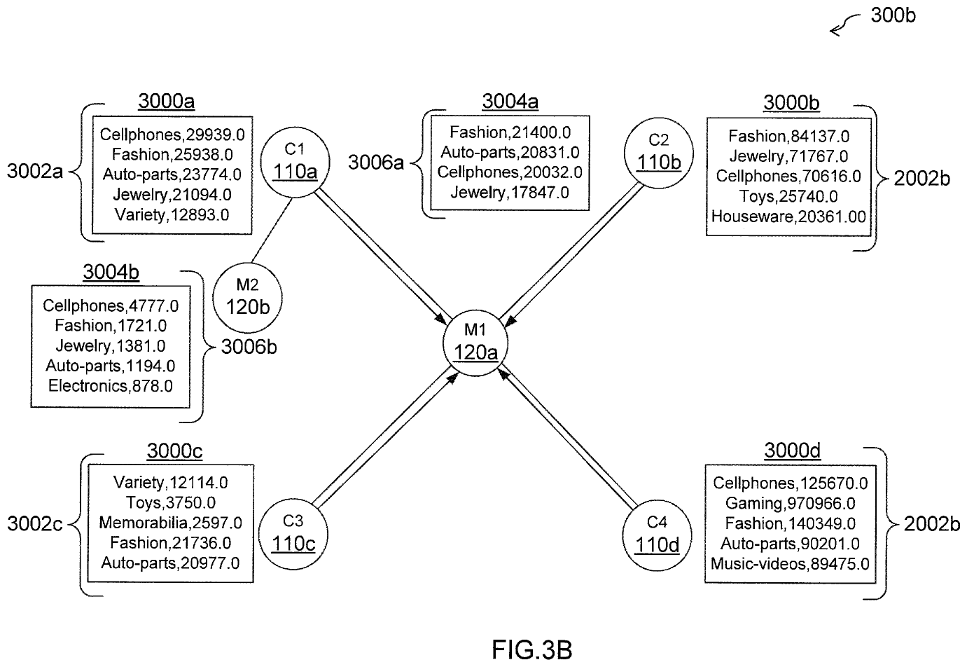

FIG. 3A is an exemplary system environment where multiple consumer vertical lists may be aggregated for a merchant, according to an embodiment. Environment 300a includes a merchant node 120a corresponding to merchant device 120 described in system 100 of FIG. 1. Additionally, environment 200a includes a user node 110a, a user node 110b, a user node 110c, and a user node 110d corresponding to user device 110 described in system 100 of FIG. 1. In this regard, environment 300a shows determined consumer vertical lists that may be aggregated to generate a merchant vertical list at merchant node 120a.

For example, user node 110a is shown having a vertical list 2000a that includes verticals 2002a each having a transaction vertical and a number of transactions shown as cellphones: 4.0, fashion: 1.0, and variety: 1.0. User node 110b similarly has a vertical list 2000b having verticals 2002b for fashion: 18.0, electronics: 7.0, variety: 5.0, auto-parts: 4.0, and cellphones: 1.0. User nodes 110c and 110d feature corresponding vertical lists, such as vertical list 2000c for user node 110c having verticals 2002c of toys: 6.0, gaming: 2.0, variety: 1.0, and memorabilia: 1.0, and vertical list 2000d for user node 110d that has verticals 2002d of cellphones: 10.0, cosmetics: 6.0, gaming: 5.0, electronics: 3.0, and fashion: 2.0.

Merchant node 120a may have transactions with all of user nodes 110a-d, and may have additional consumers not shown in environment 300a. After aggregating all of vertical lists 2000a-d and all other consumer vertical lists for the merchant associated with merchant node 120a, vertical list 2004a may be generated for all of the transactions by the merchant with its consumers. This may include other verticals for transactions by the consumers with other merchants, or may be merchant specific. For example, the first iteration may include only verticals for the transactions by the merchant with its consumers, and later iterations may include aggregated consumer transaction lists with other merchants. After aggregating, a weight may be applied to the aggregated vertical transaction list, which may be a value multiplied by the number of transactions in each vertical. Thus, vertical list 2004a shows verticals 2006a for the merchant for transactions with its consumers, such as fashion: 21400.0, auto-parts: 20831.0, cellphones: 20032.0, and jewelry: 17847.0. Once aggregated at merchant node 120a, a machine learning engine may then proceed to FIG. 3B where vertical list 2004a may be sent back to user nodes 110a-d.

FIG. 3B is an exemplary system environment where consumer vertical lists may be aggregated across multiple merchant vertical lists, according to an embodiment. Environment 300b includes merchant node 120a discussed in reference to environment 300a of FIG. 3A, as well as a merchant node 120b for another merchant similar to the merchant correspond to merchant node 120a and corresponding to merchant device 120 described in system 100 of FIG. 1. Additionally, environment 200b includes user nodes 110a-d discussed in reference to environment 300a of FIG. 3A. In this regard, environment 300b shows consumer vertical lists after being aggregated at a consumer node level from all of the consumer's merchants that each consumer transacted with.

For example, after the machine learning process aggregates and weights merchant vertical list for merchant node 120a and 120b and sends back to the account for each of user nodes 110a-d, the machine learning process may aggregate these weighted merchant vertical lists at user nodes 110a-d for determination of the first iterations of the consumer's vertical list for recommending items in a vertical. This may be the first iteration of a consumer vertical list that includes verticals that a consumer has not previously transacted within and may be used to recommend a highest scored vertical (e.g., vertical having the highest number of weighted transactions). For example, vertical list 3004a for merchant node 120a has verticals 3006a having fashion: 21400.0, auto-parts: 20831.0, cellphones: 20032.0, and jewelry: 17847.0. Merchant node 120b is also associated with a vertical list 2004b having verticals 2006a for cellphones: 4777.0, fashion: 1721.0, jewelry: 1381.0, auto-parts: 1194.0, and electronics: 878.0.

These may then be combined with the user's original vertical list from their processed transactions in a transaction history, and new verticals may be identified for items that user may have interest in based on similar merchants and consumers. In environment 300b, user nodes 110a-d are shown as having aggregated consumer vertical lists for all of their merchants. User node 110a has vertical list 3000a that includes verticals 3002a each having a transaction vertical and a number of transactions shown as cellphones: 29939.0, fashion: 25938.0, auto-parts: 23774.0, jewelry: 21094.0, and variety: 12893.0. As shown by the different coloration of auto-parts and jewelry, user node 110a has not previously transacted in these verticals. Thus, a recommendation may be based on auto-parts and/or jewelry verticals. As auto-parts has a higher score, auto-parts may be used as the vertical to recommend items within that vertical. User node 110b similarly has a vertical list 3000b having verticals 3002b for fashion: 84137.0, jewelry: 71767.0, cellphones: 70616.0, toys: 25740.0, and houseware: 20361, where toys and houseware are the new verticals for use in recommending items. User nodes 110c and 110d feature corresponding vertical lists, such as vertical list 3000c for user node 110c having verticals 3002c of variety: 12114.0, toys: 3750.0, memorabilia: 2597.0, fashion: 21736.0, and auto-parts: 20977.0 with fashion and auto-parts being new verticals and fashion having the highest score for recommending items. Vertical list 3000d for user node 110d that has verticals 3002d of cellphones: 1256670.0, gaming: 970966.0, fashion: 140349.0, auto-parts: 90201.0, and music-videos: 89475.0, with auto-parts being highest scored and used for a recommendation.

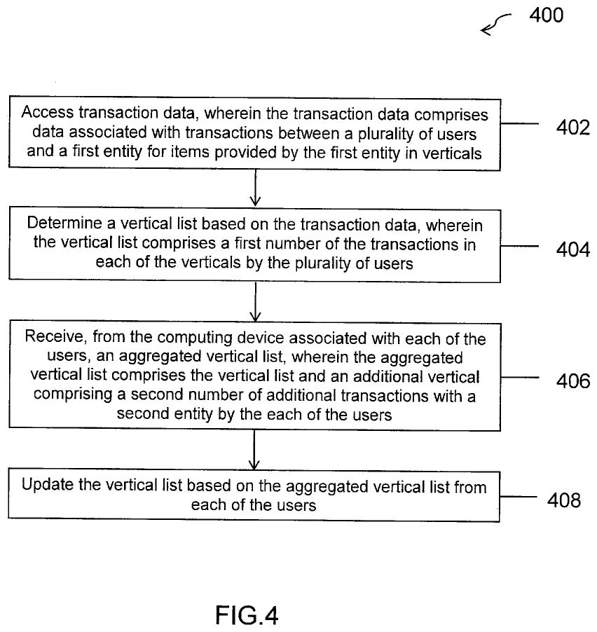

FIG. 4 is a flowchart of an exemplary process for a machine learning engine for identification of related vertical groupings, according to an embodiment. Note that one or more steps, processes, and methods described herein may be omitted, performed in a different sequence in a flowchart 400 of FIG. 4, or combined as desired or appropriate.

At step 402, transaction data is accessed, wherein the transaction data comprises data associated with transactions between a plurality of users and a first entity for items provided by the first entity in verticals. At step 404, a vertical list is determined based on the transaction data, wherein the vertical list comprises a first number of the transactions in each of the verticals by the plurality of users. An aggregated vertical list is received, from the computing device associated with each of the users, wherein the aggregated vertical list comprises the vertical list and an additional vertical comprising a second number of additional transactions with a second entity by the each of the users, at step 406. Prior to this, the method may further include weighting the vertical list based a weight applied to the first number for the each of the verticals and transmitting the vertical list to a computing device associated with each of the users. The weight may be selected by the first entity or determined by a service provider for the first entity, wherein the weight is applied to each of the first number of the transactions.

At step 408, the vertical list is updated based on the aggregated vertical list from each of the users. After updating the vertical list based on the aggregated vertical list, a reweighted vertical list may be determined based on the weight applied to the aggregated vertical list, which may be then sent to each user, user device, or user account. An engine may perform multiple iterations of the aggregating and the weighting/generating the reweighted merchant vertical list prior to the determining any recommendation rules and/or recommendations. Additionally, a machine learning engine may determine a plurality of recommendation rules based on the vertical list, wherein the plurality of recommendation rules identify groups of the verticals in the vertical list based on transactions sharing common users. The engine may further determine one of the groups for a user based on a transaction history for the user in the one of the groups and determine a shared vertical within the one of the groups based on the vertical list and the plurality of recommendation rules. The engine may then provide a recommendation for an item associated with the shared vertical. The one of the groups may be determined based on a most common vertical for the user in the transaction history, wherein the shared vertical is a next highest rated vertical in the one of the groups.

For example, an association between a first vertical and a second vertical in the vertical list may be determined and the machine learning engine may generate a recommendation rule based on the association. If a consumer's vertical list includes the first vertical as previous transactions but does not include the second vertical, a recommendation rule may be generated for the second vertical and provided to an account for the consumer's vertical list. The association may comprise a highest number of shared transactions between the first vertical and the second vertical or a churn rate in the first vertical. After receiving a response to the recommendation from the first device, the machine learning engine and the recommendation rules may be updated based on the response. A recommendation may be further based on a peer similarity between a first account for a first consumer's vertical list and a second account for a second user, as well as a third consumer's vertical list and their third account. A recommendation rule may also group the first vertical with the second vertical and identify the second vertical to the machine learning engine based on a threshold number of transactions by one of the first account, the second account, and/or a third account in the first vertical.

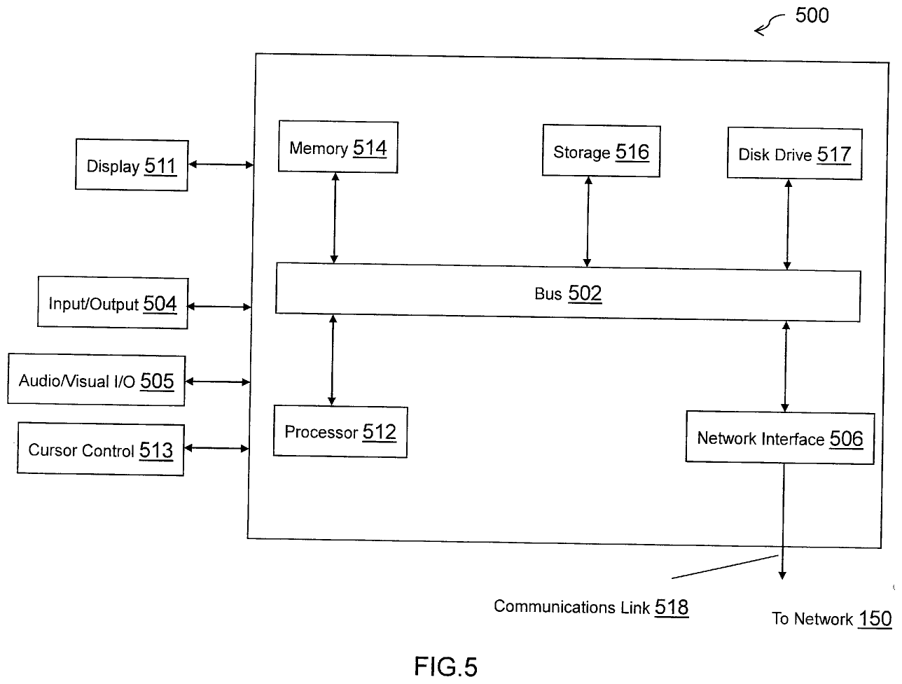

FIG. 5 is a block diagram of a computer system suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 150. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory; and
one or more hardware processors coupled to the non-transitory memory and configured to read instructions from the non-transitory memory to cause the system to perform operations comprising:
receiving, from a first device, a first vertical list of a first set of transaction verticals for first transactions processed with a merchant by a first account associated with the first device, wherein the first vertical list comprises the first set of transaction verticals and a first plurality of numbers of the first transactions processed by the first account in each of the first set of transaction verticals;
receiving, from a second device, a second vertical list of a second set of transaction verticals for second transactions processed with the merchant by a second account associated with the second device, wherein the second vertical list comprises the second set of transaction verticals and a second plurality of numbers of the second transactions processed by the second account in each of the second set of transaction verticals;
determining, using a machine learning engine, a first merchant vertical list for the merchant based on the first vertical list and the second vertical list, wherein the first merchant vertical list comprises merchant transaction verticals for the first set of transaction verticals and the second set of transaction verticals, and wherein the first merchant vertical list further comprises a third plurality of numbers of the first transactions and the second transactions in each of the merchant transaction verticals; and
transmitting the first merchant vertical list to the first account and the second account.

2. The system of claim 1, wherein the operations further comprise:
determining, using the machine learning engine, an association between a first vertical and a second vertical in the first merchant vertical list; and
generating, by the machine learning engine, a recommendation rule based on the association.

3. The system of claim 2, wherein operations further comprise:
determining that the first vertical list comprises the first vertical;
generating a recommendation associated with the second vertical based on the recommendation rule; and
providing the recommendation to the first account.

4. The system of claim 3, wherein the association comprises a highest number of shared transactions between the first vertical and the second vertical or a churn rate in the first vertical.

5. The system of claim 3, wherein the operations further comprise:
receiving a response to the recommendation from the first device; and
updating the machine learning engine based on the response.

6. The system of claim 3, wherein the second vertical list for the second account comprises the second vertical, and wherein the recommendation is further based on a peer similarity between the first account and the second account.

7. The system of claim 3, wherein the recommendation is further provided based on a peer similarity between the first account, the second account, and a third account, wherein a third vertical list for the third account comprises the second vertical, wherein the first vertical list and the second vertical list share the first vertical, and wherein the second vertical list and the third vertical list share a third vertical.

8. The system of claim 2, wherein the recommendation rule groups the first vertical with the second vertical and identifies the second vertical to the machine learning engine based on a threshold number of transactions by one of the first account, the second account, or a third account in the first vertical.

9. The system of claim 8, wherein the operations further comprise
receiving, from the first account, a first aggregated vertical list for the first account, wherein the first aggregated vertical list comprises the merchant vertical list aggregated with a second merchant vertical list received by the first account from a second merchant;
receiving, from the second account, a second aggregated vertical list for the second account, wherein the second aggregated vertical list comprises the merchant vertical list aggregated with a third merchant vertical list received by the second account from a third merchant; and
updating the first merchant vertical list based on the first aggregated vertical list and the second aggregated vertical list.

10. The system of claim 9, wherein the operations further comprise:
performing a plurality of iterations of receiving aggregates of a plurality of vertical lists from the first device and the second device until a maximum number of iterations.

11. The system of claim 9, wherein the determining the first merchant vertical list is based on a weight applied to the merchant transaction verticals, and wherein the updating the first merchant vertical list is based on the weight.

12. A method comprising:
accessing transaction data, wherein the transaction data comprises data associated with transactions between a plurality of users and a first entity for items provided by the first entity in a set of verticals;
determining a vertical list based on the transaction data, wherein the vertical list comprises a first number of the transactions in each of the set of verticals by the plurality of users;
weighting the vertical list based a weight applied to the first number for the each of the set of verticals;
transmitting the vertical list to a computing device associated with each of the users;
receiving, from the computing device associated with each of the users, an aggregated vertical list, wherein the aggregated vertical list comprises the vertical list and an additional vertical comprising a second number of additional transactions with a second entity by the each of the users; and
updating the vertical list based on the aggregated vertical list from each of the users.

13. The method of claim 12, wherein the weight is selected by the first entity or determined by a service provider for the first entity, and wherein the weight is applied to each of the first number of the transactions.

14. The method of claim 12, further comprising:
determining, by a machine learning engine, a plurality of recommendation rules based on the vertical list, wherein the plurality of recommendation rules identify groups of the set of verticals in the vertical list based on the transactions sharing common users.

15. The method of claim 14, further comprising:
determining one of the groups for a user based on a transaction history for the user in the one of the groups;
determining, by the machine learning engine, a shared vertical within the one of the groups based on the vertical list and the plurality of recommendation rules; and
providing a recommendation for an item associated with the shared vertical.

16. The method of claim 15, wherein the one of the groups is determined based on a most common vertical for the user in the transaction history, and wherein the shared vertical is a next highest rated vertical in the one of the groups.

17. A non-transitory machine-readable medium having stored thereon machine-readable instructions executable to cause a machine to perform operations comprising:
compiling, by a service provider, a merchant vertical transaction list for a first merchant, wherein the merchant vertical transaction list comprises a first vertical having a first number of transactions processed by the first merchant and a second vertical having a second number of transactions processed by the first merchant;
generating, by the service provider, a weighted merchant vertical transaction list based on a weight applied to the first number and the second number;
sending, by the service provider, the weighted merchant vertical transaction list to a device of a user;
determining, by the service provider using a machine learning engine, a recommendation rule for the user based on the weighted merchant vertical transaction list; and
determining, by the machine learning engine, a recommendation for the user based on the weighted merchant vertical transaction list and the recommendation rule.

18. The non-transitory machine-readable medium of claim 17, wherein prior to the determining the recommendation rule, the operations further comprise:
receiving, by the service provider, a user vertical transaction list from the device of the user, wherein the user vertical transaction list comprises the weighted merchant vertical transaction list and a third vertical having a third number of transactions processed with a second merchant for the user;
aggregating, by the service provider, the user vertical transaction list with the weighted merchant vertical transaction list into an aggregated merchant vertical transaction list; and
generating, by the service provider, a reweighted merchant vertical transaction list based on the weight applied to the aggregated merchant vertical transaction list, wherein the recommendation rule and the recommendation are further based on the reweighted merchant vertical transaction list.

19. The non-transitory machine-readable medium of claim 18, wherein the operations further comprise:
performing multiple iterations of the aggregating and the generating the reweighted merchant vertical transaction list prior to the determining the recommendation rule and the determining the recommendation.

20. The non-transitory machine-readable medium of claim 19, wherein prior to determining the recommendation rule, the operations further comprise:
generating a plurality of recommendation rules including the recommendation rule by the machine learning engine, wherein the plurality of recommendation rules identifies associations for a propensity to purchase items between each vertical in the reweighted merchant vertical transaction list.
